(19) United States
(12) Patent Application Publication
(10) Pub. No.: US 2023/0398762 A1
(43) Pub. Date: Dec. 14, 2023

(54) COMPOSITE PANEL INCLUDING A TAILORED COMPOSITE CORE VIA ADDITIVE MANUFACTURING

(71) Applicants: GM GLOBAL TECHNOLOGY OPERATIONS LLC, Detroit, MI (US); PRATT & MILLER ENGINEERING AND FABRICATION, INC., New Hudson, MI (US)

(72) Inventors: Ryan GERGELY, Fraser, MI (US); Gary Alan LATHAM, Whitmore Lake, MI (US); Andrew Thomas CUNNINGHAM, Cambridge, MA (US); David A. OKONSKI, Waterford, MI (US)

(21) Appl. No.: 17/836,056

(22) Filed: Jun. 9, 2022

(51) Int. Cl. B32B 3/12; B32B 37/06; B32B 37/26; B33Y 10/00; B33Y 80/00; B33Y 50/00

(52) U.S. Cl. CPC B32B 3/12; B32B 37/06; B32B 37/26; B33Y 10/00; B33Y 80/00; B33Y 50/00; B32B 2605/00

(57) ABSTRACT

A composite panel comprises a first skin and a second skin. A core is arranged between and attached to the first skin and the second skin. The core includes Z zones that are 3D printed using a thermoplastic material. Each of the Z zones abuts and is connected to another one of the Z zones. Each of the Z zones has one of D densities and at least one of the Z zones had a different density that another one of the Z zones. Z and D are integers greater than one.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to composite panels and more particularly to composite panels including a tailored composite core produced using additive manufacturing.

Carbon fiber composite panels are increasingly being used as structural components in vehicles, aircraft, and other applications. Some composite panels include a core that is sandwiched between outer skins made of glass fiber or carbon fiber. The core can be made of multiple planar core segments that are cut, hand-shaped and then bonded together to form a more complex shape. Mounting points are typically handled as separate components.

After creating the core, the outer skins are bonded to opposite sides of the core. This approach for making the core is labor intensive and design constrained. Core density is typically uniform and is not optimized for the expected loads. For smaller runs, the core can be produced using a 3D printer that prints the core using additive manufacturing. However, a single core for a part like an aerodynamic splitter for a vehicle can take more than 300 hours to print, which is both time consuming and expensive.

### SUMMARY

A composite panel comprises a first skin and a second skin. A core is arranged between and attached to the first skin and the second skin. The core includes Z zones that are 3D printed using a thermoplastic material. Each of the Z zones abuts and is connected to another one of the Z zones. Each of the Z zones has one of D densities and at least one of the Z zones had a different density that another one of the Z zones. Z and D are integers greater than one.

In other features, each of the Z zones includes an infill pattern including a repeating infill shape having a predetermined size. The repeating infill shape includes triangles. The thermoplastic material includes embedded fibers selected from a group consisting of glass fiber, aramid fiber, natural fiber, carbon fiber and combinations thereof.

In other features, connection locations are integrated with the core. Return paths of the infill pattern are located along borders between abutting ones of the Z zones. The return paths along the borders between abutting ones of the Z zones are located in overlap regions. The overlap regions are discontinuous along the borders.

In other features, openings defined in printed portions of the composite panel in planar regions of the composite panel. Planar core members bonded in the openings.

In other features, a plurality of joining sections printed in the core. A susceptor layer is arranged between the plurality of joining sections and at least one of the first skin and the second skin. The at least one of the first skin and the second skin is inductively heated to bond the susceptor layer and the plurality of joining sections of the core.

A method for making a composite panel includes modelling expected loads on a composite panel during use, wherein the composite panel includes a core bonded to a first skin and a second skin; identifying locations of Z zones in the core, wherein each of the Z zones includes a border abutting and connected to another one of the Z zones; and 3D printing the Z zones using a thermoplastic material. Each of the Z zones has one of D densities and at least one of the Z zones had a different density that another one of the Z zones. Z and D are integers greater than one.

In other features, each of the Z zones includes an infill pattern including a repeating infill shape having a predetermined size. The repeating infill shape includes triangles. The thermoplastic material includes embedded fibers selected from a group consisting of glass fiber, aramid fiber, natural fiber, carbon fiber and combinations thereof. The method includes integrating connection locations into the core.

In other features, the method includes locating return paths of the infill pattern along borders between abutting ones of the Z zones. The return paths along the borders between abutting ones of the Z zones are located in overlap regions. The overlap regions are discontinuous along the borders.

In other features, the method includes arranging openings in the composite panel in planar regions of the composite panel; and bonding planar core members in the openings.

In other features, the method includes printing a plurality of joining sections in the core; arranging a susceptor layer between the plurality of joining sections and at least one of the first skin and the second skin; and using inductive heating to bond the at least one of the first skin and the second skin to the susceptor layer and the plurality of joining sections of the core.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross-sectional view of an example of a composite panel including a tailored core and outer skins according to the present disclosure;

FIG. 2 is a plan view of an example of an infill pattern of a tailored core including hexagons;

FIG. 3 is a perspective view of a portion of a tailored core according to the present disclosure;

FIGS. 4A and 4B are plan views of examples of infill patterns of a tailored core according to the present disclosure;

FIGS. 5A through 5G are plan views of another example of infill patterns of a tailored core according to the present disclosure;

FIGS. 6 and 7 are plan views of examples of tailored cores according to the present disclosure;

FIG. 8 is a side cross-sectional view of an outer skin attached to a tailored core according to the present disclosure.

In the drawings, reference numbers may be reused to identify similar and/or identical elements.

### DETAILED DESCRIPTION

The composite panel with a tailored core according to the present disclosure will be further described below in the context of parts for a vehicle. However, the composite panel with a tailored core can be used in non-vehicle implementations. For example, the composite panel can be used for parts of aircraft or in other applications.

As will be described further below, the composite panels according to the present disclosure include tailored cores that are produced using an additive manufacturing process. For example, the additive manufacturing processes may include small pellet extrusion deposition or fused filament fabrication (FFF). The composite panels include a sparse, tailored core that is designed using zones having different core densities and automatically generated infill patterns filling each of the zones. Discontinuous overlap regions are used for connections between zones.

In some examples, the core is produced using chopped-fiber reinforced thermoplastic filaments or pellets as the material feedstock for the additive manufacturing equipment. When using this approach, the fibers are inherently aligned in a lay direction by the extrusion process to increase the strength and stiffness of the core. In some examples, the thermoplastic includes a polymer matrix material selected from a group consisting of ABS, PA6, PA6/66, and PA12, although other thermoplastics can be used.

In the composite panels described below, the density of the sparse core is varied in different zones that about one another. The zones have locations and shapes that are derived from one or more stress analyses. Automatically generated infill patterns are used in the zones rather than CAD generated patterns, which reduces time and cost. For example, the infill patterns can be generated using Simplify3D printing software, although other 3D printing software can be used.

The cores include return paths from the automatically generated infill patterns and discontinuous overlap regions for connections along borders between the zones. In some examples, there is an overlap in a range from 10% to 30%. IN other examples, there is an overlap in a range from 15% to 20%. In some examples, a joint is used to attach the core to the outer skin layers.

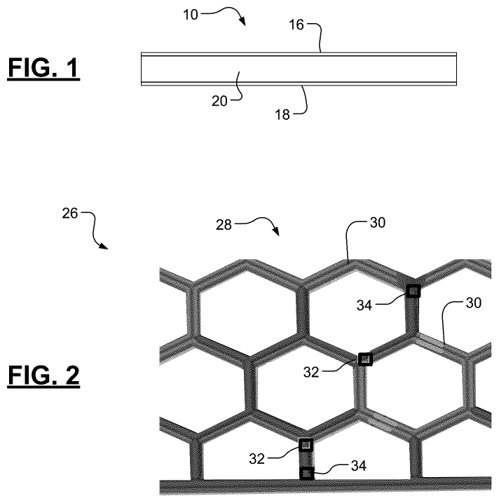

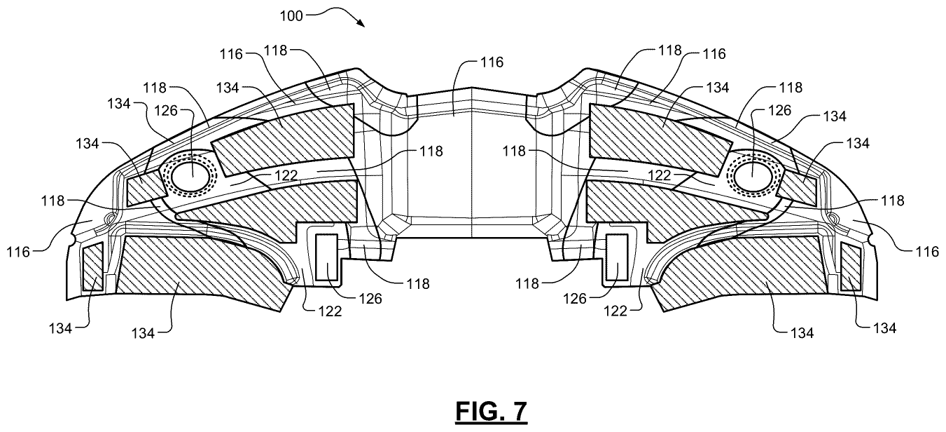

Referring now to FIG. 1, a composite panel 10 includes a core 20 and outer skin layers 16, 18. The outer skin layers 16, 18 may include sheets of fiber such as glass fiber, aramid fiber (Kevlar), natural fiber (flax), polymer sheet (with or without composite fiber filler), or carbon fiber that are attached and/or bonded to the core 20 using polymer (or using a process such as induction or resistance heating using a thermoplastic composite skin and a compatible thermoplastic core with or without a bonding or susceptor layer 168 described in FIG. 8 below).

The core 20 is produced using additive manufacturing processes and includes a plurality of different zones with infill patterns having different densities (described further below). In some examples, the infill patterns have the same basic repeating shape with different sizes. In other examples, different basic repeating shapes can be used in different zones.

In some embodiments, the core is 3D printed in successive layers that are printed over a preceding layer. The layers are printed to a predetermined height in a direction that is transverse to the outer skin layers. The densities of the infill patterns in the plurality of zones are selected based upon the expected loads in the plurality of zones, respectively, during use. The loads can be modelled using computer simulations or testing.

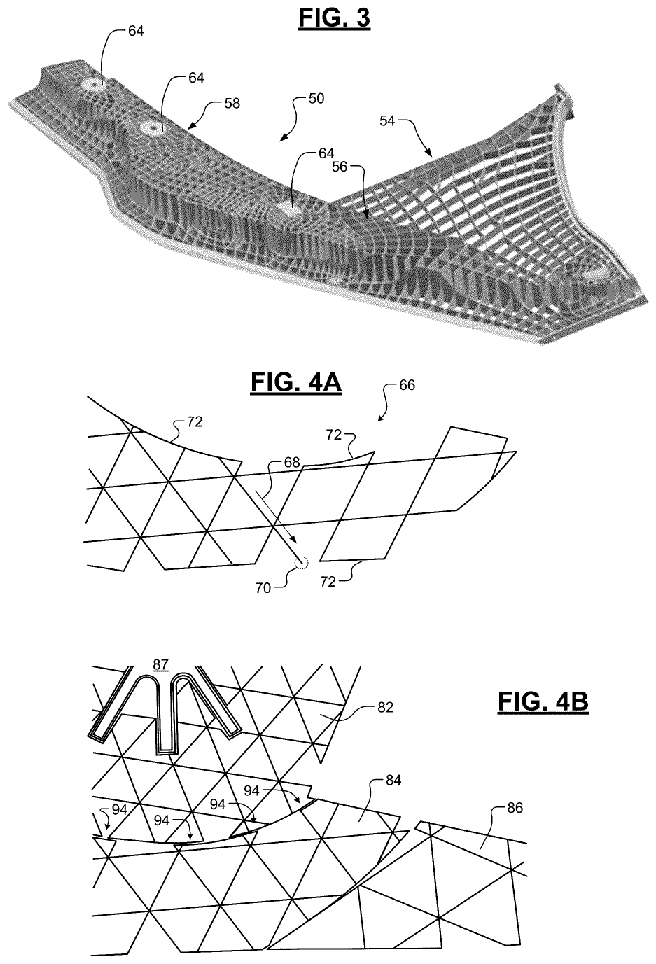

Referring now to FIG. 2, a core 26 has an infill pattern 28 that includes a repeating pattern of hexagons 30. A 3D printer may be used to print the core 26 one layer at a time using pellets or filaments that are heated to a molten state and printed by a print head. In some examples, a given layer of the hexagon pattern may include two adjacent 3D printed lines that are printed side by side and one or more subsequent layers that include only one 3D printed line.

In some examples, the filaments include glass fiber, aramid fiber (Kevlar), natural fiber (flax), or carbon fiber. In some embodiments, the filaments include a mixture of chopped carbon fiber and thermoplastic. When printing the core with a basic shape such as hexagons), the 3D printer starts (e.g. at 32) and stops (e.g. at 34) frequently for the infill pattern, which increases the time required to print a component. For example, it may take more than 300 hours to print the core 26 for an aerodynamic splitter for a vehicle. In other words, by following a normal workflow of generating the geometry of the part (using an infill pattern including hexagons) and then generating toolpaths, printing is inefficient due to a significant number of starts and stops that are required.

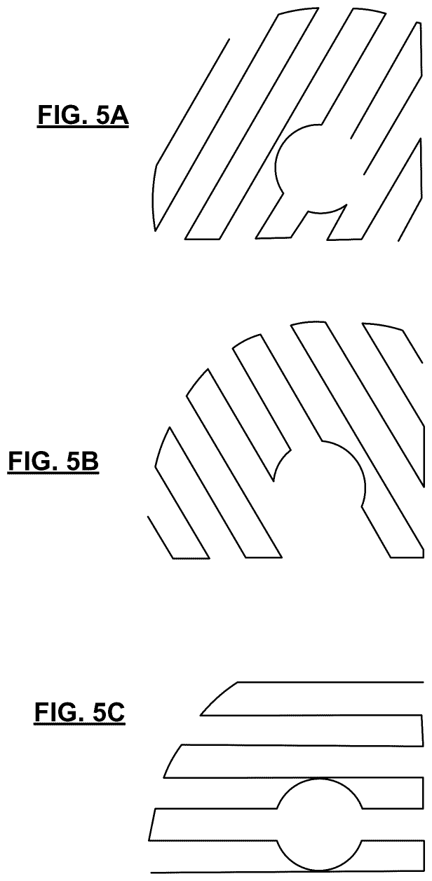

Referring now to FIG. 3, a portion of a core 50 is shown to have complex contours and to include a first zone 54, a second zone 56 and a third zone 58 having different zone densities. For example, the first zone 54, the second zone 56 and the third zone 58 have increasing zone densities, respectively, corresponding to expected maximum loads during use. For example, higher zone density or fully dense zones may be used near panel connections 64 while other locations with lower loads have lower density. Use of additively manufactured cores enables complex contours and integration of multiple components and features with different sparse densities or fully dense regions.

The core 50 has optimized cell sizes (topology optimized), integral mounting features (hard points), and integral features for panel closeout (edging). In some examples, hard points may include a hole formed in a fully dense area. This approach for manufacturing the core allows complex surfaces on both the top and bottom of the part.

During design of the core, multiple load cases are combined into a maximum stress plot. The information in the maximum stress plot is projected onto a XY plane or print plane and used to determine the core densities in various locations. Core cell size and wall thicknesses are determined/sized to meet maximum expected stress in each zone. Zone edge ribbons and/or boundaries connect variable size infill zones together.

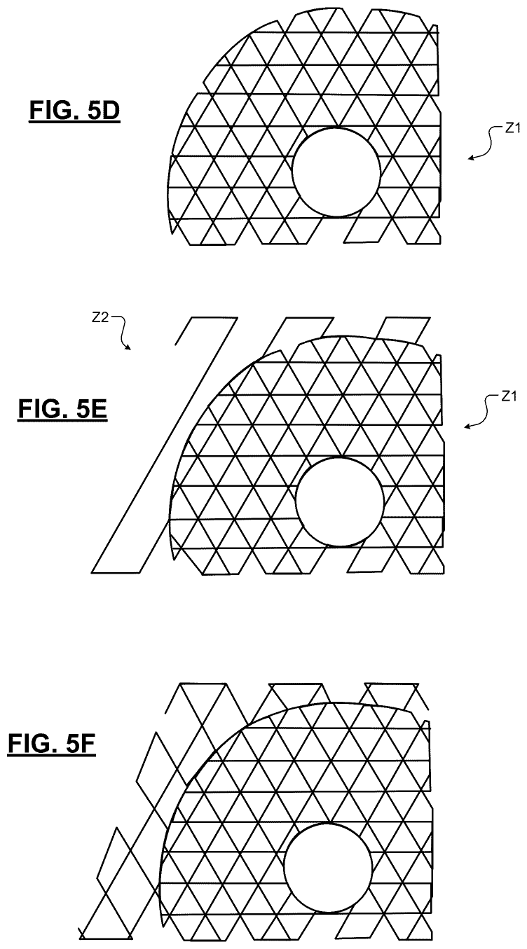

Referring now to FIGS. 4A and 4B, examples of more efficient infill patterns according to the present disclosure are shown. Variation of the core density, determined based on stress analysis, enables optimization of the core structure and reduction of overall part mass. In other words, the core is divided into zones in the print plane, where each zone has a common core density to match the expected load during use. The core density of each zone is determined by the size of repeating shape of the infill pattern. Lower core density corresponds to larger shapes in the infill pattern (e.g. an infill pattern with larger repeating triangles) while higher core density corresponds to smaller shapes in the infill pattern (e.g. an infill pattern with smaller repeating triangles). Use of the zoned approach simplifies the implementation of the manufacturing process and enables use of automatically generated infill patterns in the zones. In the examples described herein, each of the zones has a common wall thickness (i.e., the width of the material deposited by the 3D printer is the same throughout the print). However, the width of the material deposited by the 3D printer can also be varied throughout the print to affect the core density.

Selection and control of automatically generated infill patterns (e.g. triangular with return paths, in combination with thicker cell walls consisting of a single toolpath wall thickness) offer distinct print speed and quality advantages over the typical approach of drawing the CAD for the sparse core. For example, the 3D print time was reduced from over 300 hours to 39 hours for an aerodynamic splitter.

In FIG. 4A, a portion of a zone 66 within a 3D print of a part is shown. Automatic infill is performed in the zone 66. A current print path direction 68, a current print head location 70, and return paths 72 are shown. Each line of the print path is connected by a return path 72. The return paths 72 are located on boundaries of a zone that overlaps with other zones (not shown).

In FIG. 4B, zones 82, 84 and 86 are contiguous or abutting and have different cell densities. In some examples, a triangular infill pattern is used, although other patterns can be used. A fully dense area 87 is located adjacent to the zone 82. Zones 82, 84 and 86 (with decreasing densities) are connected by portions of the return paths. Use of return paths enables robust connection between the different sparse fill zones while reducing overall part mass relative to alternatives (e.g. a connecting/overlapping “ribbon”). Different density zones of the part overlap using return paths. Dedicated fully overlapping ribbon zones are reduced to partially overlapping ribbon zones using return paths rather than overlapping continuously along the ribbons.

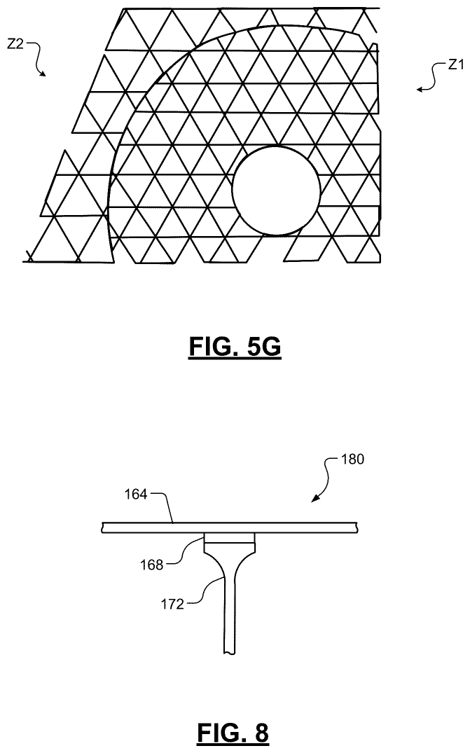

Referring now to FIGS. 5A to 5G, another illustrative example using a triangular infill pattern is shown. For a first zone Z1 having a first infill shape and size, the toolhead handles parallel pattern lines arranged at one angle. The toolhead travels at a first set angle (e.g. 60°) to produce the first lines as shown in FIG. 5A. When the toolhead intersects a boundary, it travels along that boundary until it reaches the start position of a line parallel to the first line. At the start position of the next parallel line in the zone, the tool changes direction and travels along a line parallel to the first line. The start point is determined by size of the triangles (e.g. based on infill density and width of the line). The process continues for the other parallel lines in the zone that are oriented at the first set angle.

After all of the lines at the first set angle are completed for the zone, the steps are repeated for the second angle (e.g. 120°) shown in FIG. 5B and for the third set angle (e.g. 180°) shown in FIG. 5C. The overlapping lines are shown in FIG. 5D. The process is repeated for a second zone Z2 using a second infill shape and size (different than the first infill shape and size) as shown in FIGS. 5E to 5G. In this example, the infill pattern in the second zone Z2 is larger than the infill pattern in the first zone Z1. As can be appreciated, this approach allows longer continuous toolpaths without starting and stopping, which reduces 3D print time.

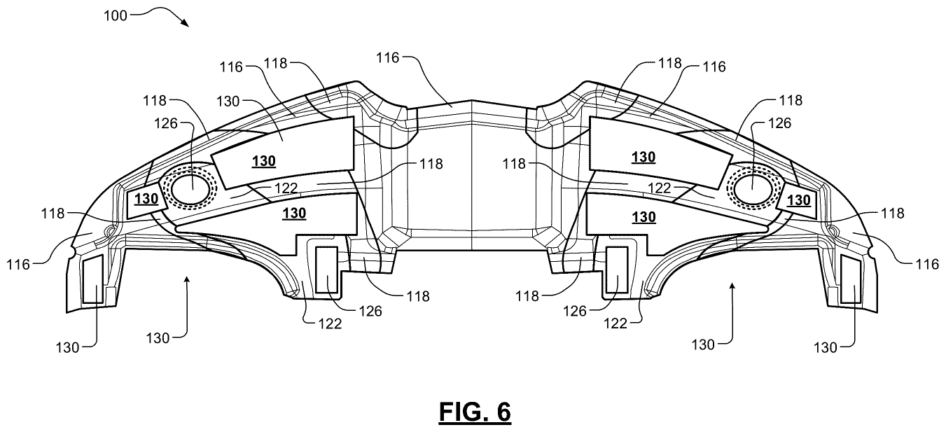

Referring now to FIGS. 6 and 7, a composite panel 100 with different integrated zone densities is shown. In FIG. 6, the composite panel includes zones 116, 118, 122, and 126 having different zone densities. In some examples, planar portions of the composite panel may be left open (e.g. at 130) to allow premanufactured sparse core material such as Nomex to be cut, shaped and/or inserted and bonded thereto. This optional technique may be used for generally planar portions of the core to reduce print time. In FIG. 7, premanufactured core members 134 are attached to the composite panel to fill the openings.

Referring now to FIG. 8, an outer skin layer 164 is shown attached to a core. Creation of a joining section 172 of the core (e.g., a “T” section at the ends of cell walls) provides surface area for the purpose of joining the outer skin layer 164. The outer skin layer 164 can use either thermoset or thermoplastic chemistry and can be adhesively bonded to the core (or resistive or inductive heating can be used).

If the skin layer 164 is made of a thermoplastic material system, then a susceptor layer 168 can be used to join skin layer 164 and the joining section 172 of the core using induction heating. If the skin layer 164 and the joining section 172 of the core are both made of the same or compatible thermoplastic material (with or without fiber reinforcement), then fusion via induction welding becomes possible enabling the high-speed fabrication of a composite sandwich structure 180. In some examples, one of the skin layer 164 and the susceptor layer 168 can be reinforced and the other of the skin layer 164 and susceptor layer 168 can be unreinforced. In other examples, the skin layer 164 and the susceptor layer 168 are reinforced with the same fibers, different types of fibers (e.g., glass and carbon), and/or different grades of the same type of fibers.

The susceptor layer 168 may include a metal mesh, conductive filled polymer, or other electrically conductive material. An inductive coil is arranged adjacent to the skin layer 164 and the susceptor layer 168 and current flows through the inductive coil. Eddy currents are induced in the susceptor layer 168, which heats the susceptor layer 168 and adjacent surfaces. Fillers may be for example metallic particles (e.g., iron particles) or fibers (e.g., discontinuous or continuous). A facing surface of the joining section 172 of the core can be flat or textured. Surface texture can enhance the robustness of the bond. Surface modification is not possible with conventional core but straightforward with the geometry freedom provided by additive manufacturing.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

1. A composite panel comprising:
a first skin;
a second skin; and
a core arranged between and attached to the first skin and the second skin,
wherein the core includes at least one layer of Z zones that are 3D printed using a thermoplastic material,
wherein each of the Z zones abuts and is connected to another one of the Z zones,
wherein each of the Z zones has one of D densities and at least one of the Z zones has a different density that another one of the Z zones,
wherein each of the Z zones includes an infill pattern having paths along borders between abutting ones of the Z zones having different densities,
wherein the paths between abutting ones of the Z zones having different densities are located in overlap regions,
wherein the overlap regions are discontinuous along the borders, and
where Z and D are integers greater than one.

2. The composite panel of claim 1, wherein each the infill pattern of each of the Z zones includes a repeating infill shape having a predetermined size.

3. The composite panel of claim 2, wherein the repeating infill shape includes triangles.

4. The composite panel of claim 1, wherein the thermoplastic material includes embedded fibers selected from a group consisting of glass fiber, aramid fiber, natural fiber, carbon fiber and combinations thereof.

5. The composite panel of claim 1, further comprising connection locations that are integrated with the core.

6-8. (canceled)

9. The composite panel of claim 1, further comprising:
openings defined in printed portions of the composite panel in planar regions of the composite panel; and
planar core members bonded in the openings.

10. The composite panel of claim 1, further comprising:
a plurality of joining sections printed in the core; and
a susceptor layer arranged between the plurality of joining sections and at least one of the first skin and the second skin,
wherein the at least one of the first skin and the second skin is inductively heated to bond the susceptor layer and the plurality of joining sections of the core.

11. A method for making a composite panel comprising:
modelling expected loads on a composite panel during use, wherein the composite panel includes a core arranged between and attached to a first skin and a second skin;
identifying locations of Z zones in the core, wherein each of the Z zones includes a border abutting and connected to another one of the Z zones; and
3D printing the Z zones using a thermoplastic material,
wherein each of the Z zones has one of D densities and at least one of the Z zones has a different density that another one of the Z zones,
wherein each of the Z zones includes an infill pattern having paths along borders between abutting ones of the Z zones having different densities,
wherein the paths between abutting ones of the Z zones having different densities are located in overlap regions,
wherein the overlap regions are discontinuous along the borders, and
where Z and D are integers greater than one.

12. The method of claim 11, wherein the infill pattern of each of the Z zones includes a repeating infill shape having a predetermined size.

13. The method of claim 12, wherein the repeating infill shape includes triangles.

14. The method of claim 11, wherein the thermoplastic material includes embedded fibers selected from a group consisting of glass fiber, aramid fiber, natural fiber, carbon fiber and combinations thereof.

15. The method of claim 11, further comprising integrating connection locations into the core.

16-18. (canceled)

19. The method of claim 11, further comprising:
arranging openings in the composite panel in planar regions of the composite panel; and
bonding planar core members in the openings.

20. The method of claim 11, further comprising:
printing a plurality of joining sections in the core;
arranging a susceptor layer between the plurality of joining sections and at least one of the first skin and the second skin; and
using inductive heating to bond the at least one of the first skin and the second skin to the susceptor layer and the plurality of joining sections of the core.
